(19) United States
(12) Patent Application Publication
(10) Pub. No.: US 2016/0016436 A1
(43) Pub. Date: Jan. 21, 2016

(54) Tire With Tread Pattern Including Sub-Surface Stiffness Tuning And Method

(71) Applicant: BRIDGESTONE AMERICAS TIRE OPERATIONS, LLC, Nashville, TN (US)

(72) Inventor: Francis J. Byrne, Franklin, TN (US)

(21) Appl. No.: 14/767,408

(22) PCT Filed: Mar. 12, 2014
(86) PCT No.: PCT/US14/23859

§ 371 Date: Aug. 12, 2015

Related U.S. Application Data
(60) Provisional application No. 61/800,599, filed on Mar. 15, 2013.

(51) Int. Cl. B60C 11/03; B29D 30/06; B60C 11/13

(52) U.S. Cl. CPC B60C 11/0306; B60C 11/0327; B60C 11/1369; B29D 30/0601; B60C 2011/0334

(57) ABSTRACT

A tire has an axis of rotation and a tread pattern that includes a plurality of tread blocks having differing circumferential shear stiffness values. The tread pattern also includes a plurality of sub-surface features that are operatively associated with at least some of the tread blocks. The combination of a tread block and a sub-surface feature can alter the circumferential shear stiffness value of tread block to thereby tune the tread pattern. A method of manufacture is also included.

### BACKGROUND

The subject matter of the present disclosure broadly relates to the art of tires and, more specifically, to a tire including a tread pattern that includes a plurality of different sized tread blocks and a plurality of sub-surface stiffness tuning elements interconnecting the tread blocks. A method of manufacture is also included.

The subject matter of the present disclosure may find particular application and use in association with pneumatic tires, such as the type and/or kind having tire treads that include noise and/or vibration reducing patterns and configuration, and is illustrated and described herein with specific reference to such constructions. It is to be understood, however, that the subject matter of the present disclosure is broadly applicable to non-pneumatic tires (e.g., solid rubber tires) and is also suitable for inclusion on tires used in association with one or more of a wide variety of applications (e.g., passenger, light truck, heavy-duty highway, agricultural, ATV, construction and forestry applications). As such, the specific reference herein to pneumatic tires for use in a particular application is merely exemplary and not intended to be limiting.

Tires having tread patterns with tread lugs or blocks of different sizes, shapes, pitch lengths and/or pitch ratios are generally well known and commonly used. Tires having such tread patterns have been shown to provide improved comfort and/or performance during use in association with wheeled vehicle, such as by reducing the generation of undesirable vibrations and noises at at least certain frequencies and/or ranges of frequencies. Notwithstanding the widespread adoption and overall success of tires having such tread patterns, it is believed desirable to develop tires and tire tread patterns that may be capable of further reducing the generation of noises and/or vibrations, providing improved wear properties of the tire and tire tread pattern, and/or otherwise advancing the art of tire performance and/or manufacturing.

### SUMMARY OF THE INVENTION

One example of a tire in accordance with the subject matter of the present disclosure can have an axis of rotation and can include a tread extending circumferentially about the axis. The tread can include a plurality of tread blocks that are arranged in a tread pattern. The plurality of tread blocks can include a plurality of occurrences of a first tread block having a first theoretical circumferential shear (TCS) stiffness value and a plurality of occurrences of a second tread block having a second TCS stiffness value that is greater than the first TCS stiffness value. The plurality of occurrences of the first tread block and the plurality of occurrences of the second tread block can be disposed in spaced relation to one another in a circumferential row extending about the axis and in a predetermined sequence of first and second tread blocks. A plurality of sub-surface features can include a plurality of occurrences of at least a first sub-surface feature. The plurality of occurrences of the first sub-surface feature can be operatively associated with at least the plurality of occurrences of the first tread block such that a combination of one of the first tread blocks and one of the first sub-surface features has a first adjusted circumferential shear (ACS) stiffness value that is greater than the first TCS stiffness value.

Another example of a tire in accordance with the subject matter of the present disclosure can have an axis of rotation, and can include an elastomeric tire casing and a tread. The elastomeric tire casing can extend circumferentially about the axis, and can include an outer surface. The tread can extend circumferentially about the and into the elastomeric tire casing from along the outer surface. The tread can include at least one rib extending circumferentially about the axis that includes a plurality of tread blocks disposed in spaced relation to one another with a laterally-extending groove disposed between adjacent ones of the plurality of tread blocks. The plurality of tread blocks can include a plurality of occurrences of a first tread block having a first theoretical circumferential shear (TCS) stiffness value and a plurality of occurrences of a second tread block having a second TCS stiffness value that is greater than the first TCS stiffness value. A plurality of sub-surface features can include a plurality of occurrences of a first sub-surface feature with at least one of the first sub-surface features operatively connected to each of the plurality of occurrences of the first tread block such that the combination of the at least one first sub-surface feature and the first tread block have a first adjusted circumferential shear (ACS) stiffness value that is closer to the second TCS stiffness value than the first TCS stiffness value.

One example of a method of manufacturing a tire in accordance with the subject matter of the present disclosure can include providing a quantity of elastomeric material dimensioned to at least partially form a tire casing. The method can also include forming a tire casing including a casing wall extending circumferentially about an axis of rotation. The method can further include forming a tread pattern along at least a portion of the casing wall. The tread pattern can include a plurality of tread blocks and a plurality of sub-surface features. The plurality of tread blocks can include a plurality of occurrences of a first tread block and a plurality of occurrences of a second tread block. The plurality of occurrences of the first tread block and the plurality of occurrences of the second tread block can be disposed in spaced relation to one another in a circumferential row extending about the axis and in a predetermined sequence of first and second tread blocks. The plurality of sub-surface features can include a plurality of occurrences of at least a first sub-surface feature with the plurality of occurrences of the first sub-surface feature operatively associated with at least the plurality of occurrences of the first tread block. The method can also include curing the tire casing to form a tread pattern in which the plurality of occurrences of the first tread block have a first theoretical circumferential shear (TCS) stiffness value, the plurality of occurrences of the second tread block have a second TCS stiffness value that is greater than the first TCS stiffness value, and a combination of one of the first tread blocks and one of the first sub-surface features has a first adjusted circumferential shear (ACS) stiffness value that is closer to the second TCS stiffness value than the first TCS stiffness value.

### BRIEF DESCRIPTION OF THE DRAWINGS

FIG. 1 is a diagrammatic side view of one example of a tire and wheel assembly that includes a tire with a tread pattern in accordance with the subject matter of the present disclosure.

FIG. 2 is a diagrammatic cross-sectional view of the tire and wheel assembly in FIG. 1 taken from along line 2-2 thereof.

FIG. 3 is a diagrammatic plan view of one example of a portion of a tread pattern in accordance with the subject matter of the present disclosure, such as the tread pattern of the tire in FIGS. 1 and 2 shown from along line 3-3 in FIG. 2.

FIG. 4 a cross-sectional side view, taken from along line 4-4 in FIG. 3, of a portion of a tire on a road surface.

FIG. 5 is an enlarged diagrammatic side view of one example of a portion of a tread pattern in accordance with the subject matter of the present disclosure, such as the portion of the tire identified as Detail 5 in FIG. 4.

FIG. 6 is an enlarged diagrammatic side view of another example of a portion of a tread pattern in accordance with the subject matter of the present disclosure.

FIG. 7 is a further enlarged diagrammatic side view of the portion of the tread pattern identified as Detail 7 in FIG. 6 illustrating deflections of a tread block.

FIG. 8 is a graphical representation of one example of a method of manufacturing a tire in accordance with the subject matter of the present disclosure.

### DETAILED DESCRIPTION

Turning now to the drawings, it is to be understood that the showings are for purposes of illustrating examples of the subject matter of the present disclosure and are not intended to be limiting. Additionally, it will be appreciated that the drawings are not to scale and that portions of certain features and/or elements may be exaggerated for purpose of clarity and ease of understanding.

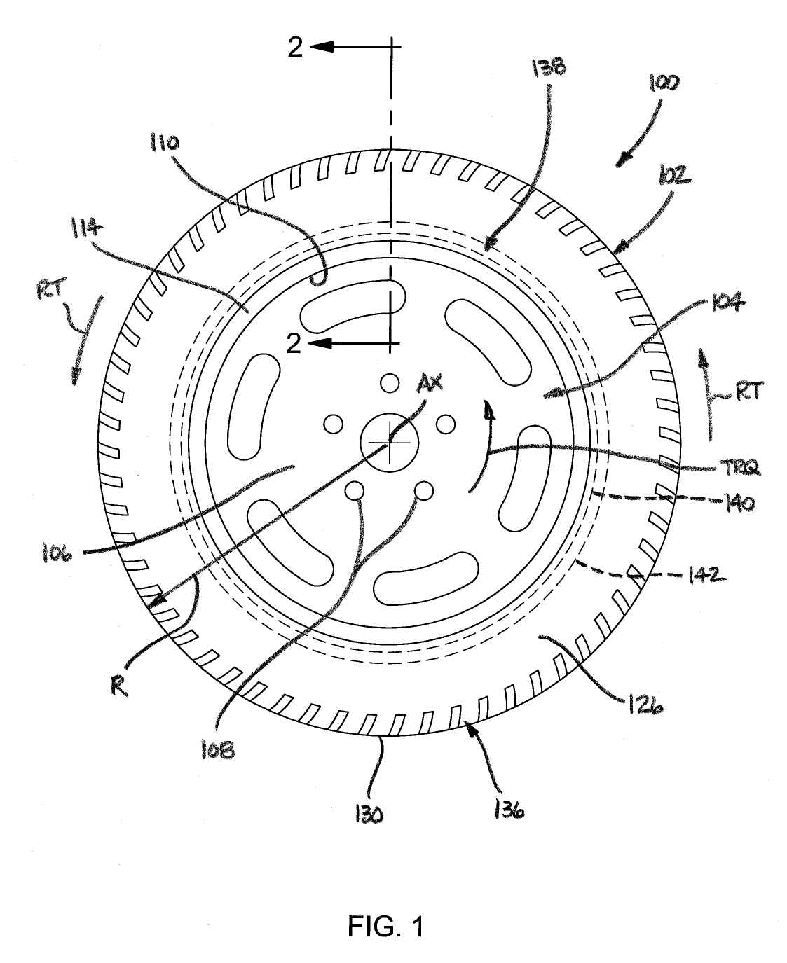

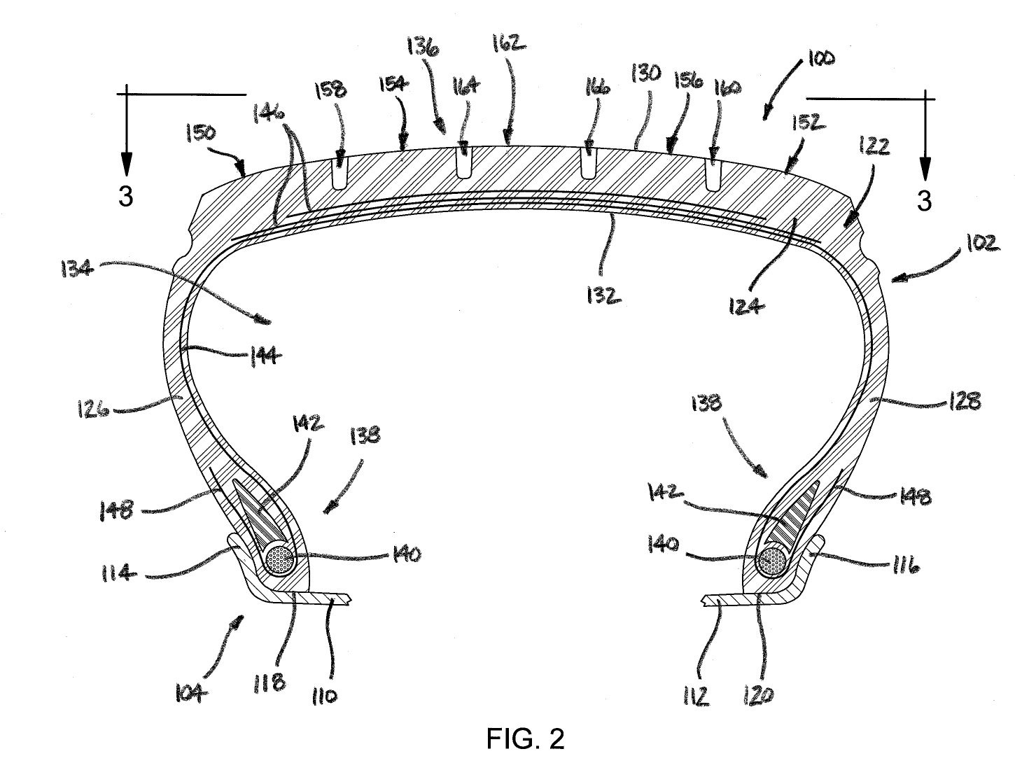

FIG. 1 illustrates a tire and wheel assembly 100 that includes a tire 102 installed on a conventional wheel 104. It will be appreciated that the tire can be of any suitable type, kind, construction and/or configuration. As one non-limiting example, tire 102 can be a pneumatic tire that can be mounted on wheel 104 in a manner that permits operation and use of the tire in an inflated condition. In the exemplary arrangement in FIGS. 1 and 2, wheel 104, which can be of any suitable type, kind, construction and/or configuration, is shown as including a mounting hub 106 having a plurality of mounting holes 108 in a suitable hole pattern. Wheel 104 is also shown as including opposing rim walls 110 and 112 (FIG. 2) that terminate at corresponding flanges 114 and 116. As illustrated in FIG. 2, bead seats 118 and 120 are respectively formed along rim walls 110 and 112 adjacent flanges 114 and 116.

Tire 102 extends circumferentially about an axis AX (FIG. 1) and includes an elastomeric casing 122 (FIG. 2) that has a crown portion 124 and axially-spaced sidewalls 126 and 128 that extend radially inward from along crown portion 124. The crown portion includes an outer surface 130 and an inner surface 132 that at least partially defines a tire cavity 134. A tread pattern 136 can be provided along outer surface 130 of crown portion 124 in accordance with the subject matter of the present disclosure.

In the exemplary arrangement shown in FIGS. 1 and 2, pneumatic tire 102 includes bead areas 138 that form the radially-inward extent of sidewalls 126 and 128. The bead areas are dimensioned or otherwise adapted to form an air-tight relationship along bead seats 118 and 120 in an installed condition of pneumatic tire 102 on wheel 104. As such, when mounted on a wheel, pneumatic tire 102 can be inflated through a conventional valve (not shown) that is operatively connected with tire cavity 134, such as through one of rim walls 110 and 112 of wheel 104, for example. Additionally, bead areas 138 of pneumatic tire 102 are each shown as including bead reinforcing elements in the forms of a bead core 140 and a bead filler 142. It will be appreciated that bead areas having a wide variety of combinations of shapes, sizes, features and elements have been developed and can be included on pneumatic tire 102. Non-limiting examples of such features and elements include bead toe features, bead heel features, bead flippers, bead chippers, and chaffing strips.

As is well known in the art, pneumatic tires, such as pneumatic tire 102, for example, also include one or more plies containing a multiplicity of closely-spaced radial reinforcing cords or wires that extend across the crown portion of the tire casing and radially inward along the sidewalls of the tire casing. In the exemplary arrangement in FIGS. 1 and 2, tire casing 122 (FIG. 2) shown as being reinforced by a weftless radial ply 144 that extends across crown portion 124 and along sidewalls 126 and 128 toward bead areas 138. Further reinforcement of the tire can be provided by one or more annular belts, such as belts 146 that extend circumferentially along crown portion 124, for example. Radial ply 144 and belts 146 can be fabricated of any suitable material or combination of materials, such as steel wires or suitable textile fibers, for example, as is well known in the art.

Bead cores 140 take the form of substantially-inextensible, endless rings that are embedded within bead areas 138. One function of bead reinforcing elements (e.g., bead cores 140) is to establish and maintain the cross-sectional dimension of bead areas 138 and the openings formed thereby such that the pneumatic tire can be mounted along corresponding bead seats of an associated wheel (e.g., bead seats 118 and 120 of wheel 104), such as may be established by industry standards and conventions.

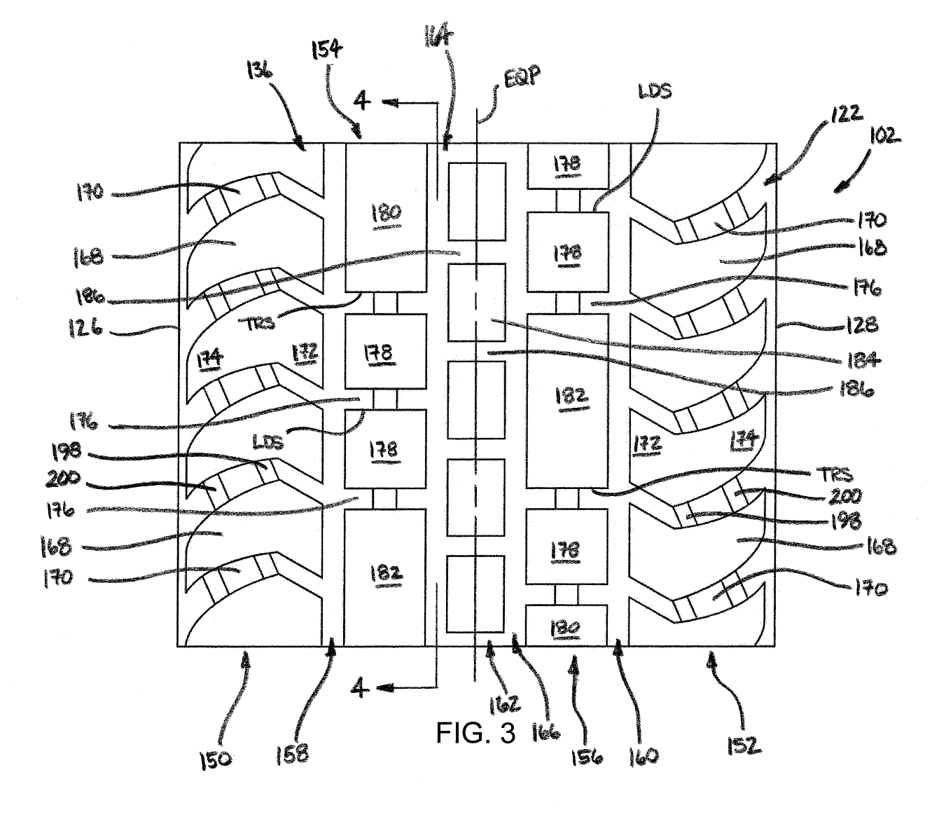

Another function of bead reinforcing elements (e.g., bead cores 140) is to anchor radial plies, such as radial ply 144, for example, as the same extend across the tire carcass between the opposing bead areas. It will be appreciated that such radial plies can be anchored by bead cores 140 in any suitable manner. For example, radial ply 144 is shown in FIGS. 2 and 3 as extending from along sidewalls 126 and 128 toward bead areas 138. Radial ply 144 extends in a radially-inward direction along an axially-inward side of bead core 140 and through the opening formed by the bead core. Outer ends 148 of radial ply 144 are turned up along an axially-outward side of bead core 140 and return in a radially-outward direction along sidewalls 126 and 128. Bead fillers 142 are shown disposed adjacent bead cores 140 in an area between radial ply 144 and outer ends 148, and can operate to at least partially fill any gap between radial ply 144 and outer end 148 and/or can operate to provide added rigidity and/or stiffness to the bead area. It will be appreciated, however, that other arrangements and/or configurations could alternately be used, and that the arrangement shown is merely exemplary.

It will be recognized that treads of tires typically include a plurality of tread blocks or lugs that are disposed circumferentially along the outer surface of the tire. And, it will be appreciated that a wide variety of types, kinds and configurations of tread patterns have been developed that provide differing performance characteristics and are used in connection with a broad range of applications. Accordingly, it is to be distinctly understood that the subject matter of the present disclosure can be implemented and used in connection with any suitable configuration and/or arrangement of tread lugs and/or tread patterns, and that the arrangement of tread lugs shown and described herein is merely exemplary and not intended to be interpreted as limiting.

In some cases, a conventional tread pattern of a tire can include a plurality of tread blocks disposed in spaced relation to one another around the outer surface of a tire and oriented in a circumferentially-extending row, which may also be referred to in the art as a “rib” or “circumferential rib”. Typically, a finite number of tread block variations are included in a given circumferential rib of a given tire tread pattern, such as from two (2) to seven (7) different tread block variations having a corresponding number of two (2) to seven (7) TCS stiffness values. Normally, two or more occurrences of each tread block are included in a conventional tread pattern. Additionally, each of the plurality of tread blocks can have one of two or more different theoretical circumferential shear (TCS) stiffness values, such as may be attributed to the size, shape, configuration, arrangement and/or other physical characteristics of the tread blocks, for example. As such, the plurality of tread blocks can have theoretical circumferential shear stiffness values that vary widely from tread block to tread block.

In some cases, conventional tread pattern designs can also include sub-surface features, such as tie bars, for example, that extend between and operatively interconnect adjacent tread blocks. However, the tie bars and/or other sub-surface features of conventional tread patterns are typically of a uniform size, shape, configuration and arrangement. As such, while the inclusion of tie bars and/or other sub-surface features of conventional tread patterns may increase the TCS stiffness values of the tread blocks of a given circumferential rib, the increase in TCS stiffness value is, typically, approximately uniform for all of the tread blocks in that circumferential rib. That is, the wide variation in TCS stiffness values from tread block to tread block is typically not altered or improved by the inclusion of conventional tie bars and/or other conventional sub-surface features.

A tread pattern of a tire in accordance with the subject matter of the present disclosure can include at least one circumferential rib formed from a plurality of tread blocks disposed in spaced relation to one another around the outer surface of a tire. Each of the plurality of tread blocks can have one of two or more theoretical circumferential shear (TCS) stiffness values, such as, for example, may be attributed to the size, shape, configuration, arrangement and/or other physical characteristics of the tread blocks. Additionally, a tread pattern of a tire in accordance with the subject matter of the present disclosure includes one or more sub-surface features with the one or more sub-surface features disposed adjacent at least one tread block but less than all of the tread blocks of the plurality of tread blocks in the at least one circumferential rib.

In a preferred arrangement, a tread pattern in accordance with the subject matter of the present disclosure can include at least one circumferential rib formed from a plurality of tread blocks that include a plurality of occurrences of a first tread block having a first TCS stiffness value and a plurality of occurrences of a second tread block having a second TCS stiffness value that is greater than the first TCS stiffness value of the first tread blocks. In the preferred arrangement, the tread pattern can also include a plurality of occurrences of at least a first sub-surface feature disposed in operative engagement or otherwise associated with a corresponding plurality of occurrences of the first tread block such that the first TCS stiffness value of at least a plurality of the first tread blocks is increased to a first adjusted circumferential shear (ACS) stiffness value that is greater than the first TCS stiffness value. In such cases, the first ACS stiffness value can be closer in value to the second TCS stiffness value than the first TCS stiffness value is to the second TCS stiffness value. In this manner, the difference between the stiffness values of the first and second tread blocks can be reduced.

In a more preferred arrangement, a tread pattern in accordance with the subject matter of the present disclosure can include at least one circumferential rib formed from a plurality of tread blocks that include a plurality of occurrences of each of at least a first tread block having a first TCS stiffness value, a second tread block having a second TCS stiffness value and a third tread block having a third TCS stiffness value. In some cases, the second TCS stiffness value can be greater than the first TCS stiffness value and the third TCS stiffness value can be greater than the second TCS stiffness value. The tread pattern can also include a plurality of sub-surface features that include a plurality of occurrences of each of at least a first sub-surface feature and a second sub-surface feature. The plurality of occurrences of the first sub-surface feature being operatively associated with a corresponding plurality of occurrences of the first tread block such that the first TCS stiffness value is increased to a first adjusted circumferential shear (ACS) stiffness value that is closer in value to the third TCS stiffness value than the first TCS stiffness value is to the third TCS stiffness value. The plurality of occurrences of the second sub-surface feature being operatively associated with a corresponding plurality of occurrences of the second tread block such that the second TCS stiffness value is increased to a second ACS stiffness value that is closer in value to the third TCS stiffness value than the second TCS stiffness value is to the third TCS stiffness value. In some cases, the tread pattern can, optionally, include a plurality of occurrences of a third sub-surface feature that are operatively associated with a corresponding plurality of the third tread block such that the third TCS stiffness value is increased to a third ACS stiffness value.

As discussed above, a plurality of tread blocks forming a circumferential rib can include any suitable number of tread block variations, such as tread blocks having from two (2) to twenty (20) different TCS stiffness values. Additionally, it will be appreciated that any suitable number of sub-surface features can be used, such as from two (2) to twenty (20) sub-surface feature variations capable of generating a corresponding number of adjustments to the TCS stiffness values of the different tread block variations with which the sub-surface features may be operatively associated. Additionally, it will be appreciated that any combination of tread block variations and sub-surface feature variations could be used. In a preferred arrangement, however, a tread pattern in accordance with the subject matter of the present disclosure can have a resulting range of relative stiffness values (e.g., lowest ACS stiffness value to highest TCS or ACS stiffness value) for a plurality of tread blocks of from approximately 70 percent to approximately 130 percent of the average stiffness value for the plurality of tread blocks. In a more preferred embodiment, the tread pattern can have a resulting range of from approximately 80 percent to approximately 120 percent of the average stiffness value for the plurality of tread blocks.

A tread pattern of a tire in accordance with the subject matter of the present disclosure can include a reduced range of circumferential shear stiffness values from the least stiff/most flexible tread blocks to the most stiff/least flexible tread blocks. In this manner, improved consistency of circumferential shear stiffness values between tread blocks in a given circumferential row or rib can be achieved. Tread blocks having greater circumferential shear stiffness values may be provided with little or no additional bolstering, buttressing and/or support beyond the TCS stiffness value generated by the size, shape, arrangement, configuration and/or other physical characteristics of the tread blocks. Alternately, tread blocks having lesser circumferential shear stiffness values may be provided with increased bolstering, buttressing and/or support to increase the TCS stiffness value to an ACS stiffness value that is greater than the TCS stiffness value.

It will be recognized and understood that the plurality of tread blocks and plurality of sub-surface features can be of any suitable size, shape, form, construction, configuration and/or arrangement, and that any combination of tread blocks and sub-surface features in accordance with the subject matter of the present disclosure can be used.

One non-limiting example of a tread pattern in accordance with the subject matter of the present disclosure is shown in greater detail in FIGS. 3-5 and is identified therein as tread pattern 136. In a preferred arrangement, a tread pattern in accordance with the subject matter of the present disclosure can include at least one circumferential rib and, more preferably, can include at least two circumferential ribs that are laterally spaced laterally from one another and separated by at least one circumferential groove that is disposed therebetween. With reference to FIG. 3, it will be recognized that tread pattern 136 is shown as being substantially symmetrical relative to equatorial plane EQP and includes ribs 150 and 152 that are disposed laterally outward from equatorial plane EQP adjacent sidewalls 126 and 128, respectively. Tread pattern 136 is also shown as including ribs 154 and 156 that are spaced laterally inward from ribs 150 and 152 with circumferential grooves 158 and 160 respectively disposed therebetween. A rib 162 is disposed laterally inward from ribs 154 and 156 such that circumferential grooves 164 and 166 are disposed between rib 162 and ribs 154 and 156, respectively.

Ribs 150 and 152 are shown as being formed from a plurality of tread blocks 168 that are disposed in circumferentially-spaced relation to one another such that adjacent tread blocks are separated by grooves 170 that extend in a generally lateral direction across the tire. Additionally, tread blocks 168 are shown as including a first, wider end 172 and a second, narrow end 174, though it will be appreciated that tread blocks of any suitable size and/or shape could be used. Ribs 154 and 156 are shown as being formed from a plurality of tread blocks that are disposed in circumferentially-spaced relation to one another such that adjacent tread blocks are separated by grooves 176 that extend in a generally lateral direction. It will be recognized that the plurality of tread blocks from which ribs 154 and 156 are at least partially formed include tread blocks 178, 180 and 182, which are shown as being of different sizes, shapes and having different physical characteristics such as may be the result of a noise-reducing tread design, for example. As a result of the difference in sizes, shapes and/or other physical characteristics, tread blocks 178, 180 and 182 would be expected to have different circumferential shear stress values, such as has been described above, for example. Furthermore, rib 162 is shown as being formed from a plurality of tread blocks 184 that are disposed in circumferentially-spaced relation to one another such that adjacent tread blocks are separated by grooves 186 that extend in a generally lateral direction.

As discussed above, the plurality of occurrences of one or more sub-surface features and/or elements of a tread pattern of a tire in accordance with the subject matter of the present disclosure can be of any suitable size, shape, form, construction, configuration and/or arrangement. Non-limiting examples of sub-surface features and/or elements of a tread pattern in accordance with the subject matter of the present disclosure can include tie bars that extend between and operatively interconnect adjacent tread blocks in a circumferential rib, variations in skid depth between adjacent tread blocks, and/or any combination of tie bars and skid depth variations.

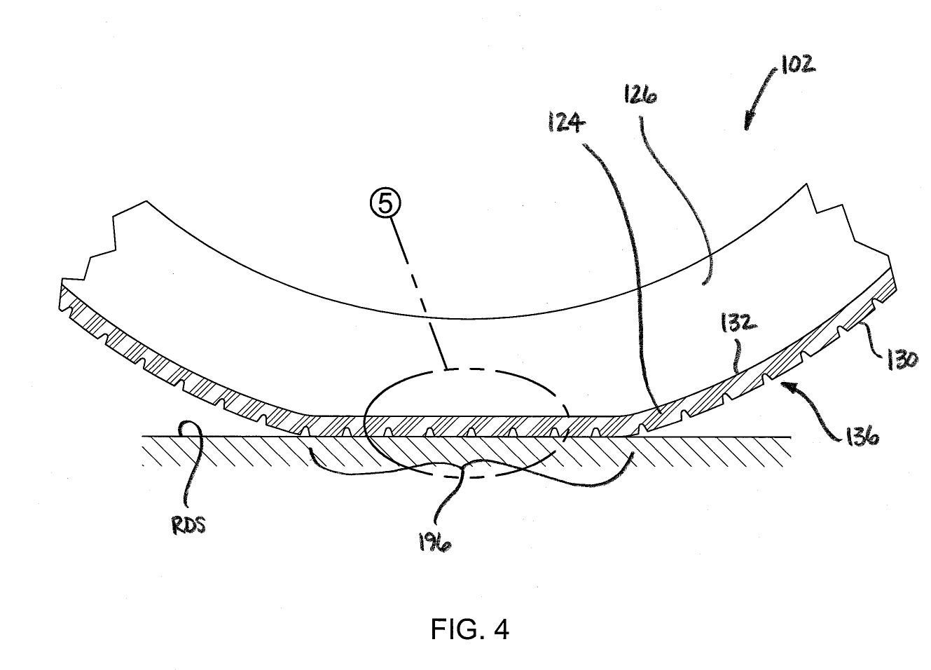

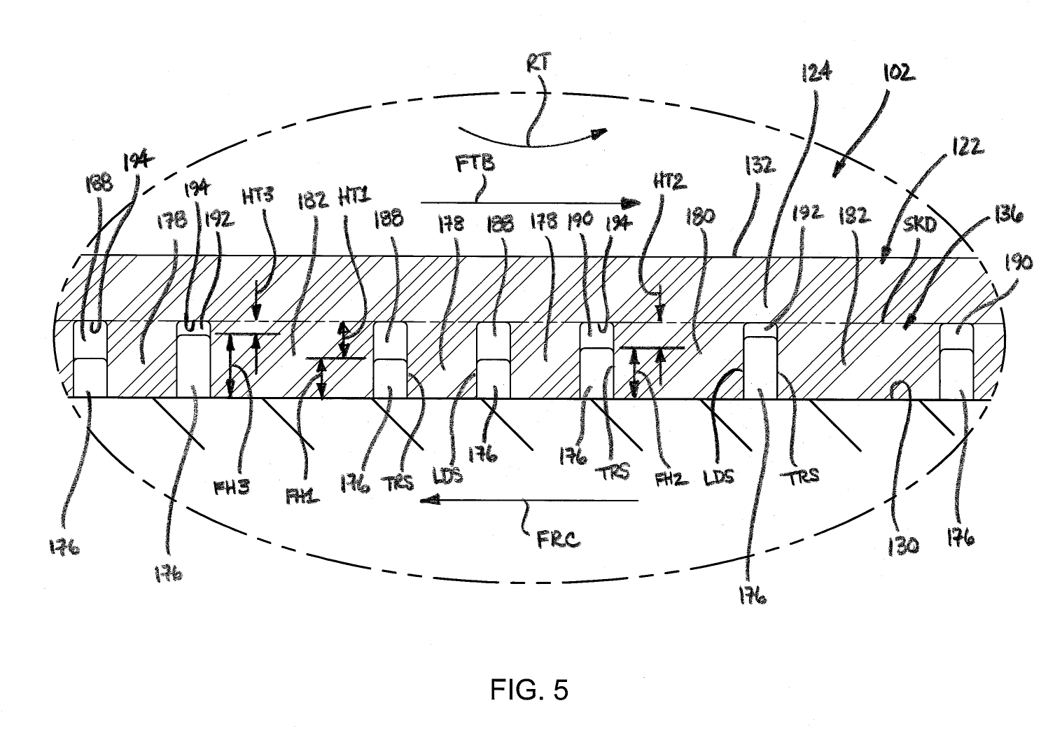

Tread pattern 136 is shown in FIGS. 3 and 5 as including sub-surface features in the form of tie bars 188, 190 and 192 that are disposed along at least one surface of tread blocks 178, 180 and 182, respectively. Lateral grooves 176 extend into crown portion 124 of tire casing 122 from along outer surface 130 to a bottom surface 194 that is disposed at a skid depth, which is represented in FIG. 5 by dashed line SKD. Tire 102 is shown in FIG. 4 during use such that a tire footprint or contact patch 196 is formed along a road or other surface RDS. In use, tire 102 rotates about axis AX, which rotation is represented by arrow RT in FIGS. 1 and 5, and adjacent tread blocks of tread pattern 136 are displaced into contact with road surface RDS, along tire footprint 196 and out of contact with road surface RDS. As a result, tread blocks 178, 180 and 182 can include a forward or leading surface LDS and a rearward or trailing surface TRS which can alternate depending upon the direction of rotation of the tire. In the arrangement shown in FIGS. 3 and 5, a leading surface of one tread block and a trailing surface of an adjacent block of a common circumferential rib are disposed in generally facing relation to one another.

As indicated above, if two or more variations of sub-surface features and/or elements are included, it will be appreciated that such variations can differ from one another in any suitable manner, such as by including differing shapes, sizes, quantities, orientations, arrangements, configurations and/or constructions, in any combination.

For example, in some cases, quantities of one (1) and zero (0) tie bars could be used in which a plurality of occurrences of one tread block (e.g., tread blocks having a lesser circumferential shear stiffness) are buttressed by a tie bar in at least one circumferential direction and a plurality of occurrences of another tread block (e.g., tread blocks having a greater circumferential shear stiffness) are unsupported by an adjacent tie bar height in at least one circumferential direction.

As another example, in some cases, quantities of one (1), two (2) and three (3) tie bars could be used. In such an example, a plurality of occurrences of one tread block (e.g., tread blocks having a lesser circumferential shear stiffness) are buttressed by a quantity of three tie bars that are disposed adjacent one another and extend in at least one circumferential direction. A plurality of occurrences of another tread block (e.g., tread blocks having a greater circumferential shear stiffness) are buttressed by a quantity of only one tie bar that extends in at least one circumferential direction. And, a plurality of occurrences of a further tread block (e.g., tread blocks having an intermediate circumferential shear stiffness) are buttressed by a quantity of two tie bars that are disposed adjacent one another and extend in at least one circumferential direction. In such examples, the one, two and three tie bars could be substantially identical to one another such that the variations in bolstering provided thereby can be attributed to the differences in quantity of the tie bars.

In the arrangement shown in FIGS. 3-5, tie bars 188, 190 and 192 have an approximately common width and vary in height. As such, tread blocks 178, 180 and 182 have differing unsupported heights from the tie bar to outer surface 130 of the tire. As identified in FIG. 5, tie bars 188 are disposed along at least trailing surface TRS of tread blocks 178 and have a height HT1 such that tread blocks 178 have a corresponding unsupported free height FH1. Tie bars 190 are disposed along at least trailing surface TRS of tread blocks 180 and have a height HT2 that is less than height HT1 of tie bars 188. As such, tread blocks 180 have a corresponding unsupported free height FH2 that is greater than free height HT1 of tread blocks 178. Additionally, tie bars 192 are disposed along at least trailing surface TRS of tread blocks 182 and have a height HT3 that is less than height HT2 of tie bars 190. As such, tread blocks 182 have a corresponding unsupported free height FH3 that is greater than free height HT2 of tread blocks 180.

In some cases, the tie bars can have a generally rectangular cross-sectional shape and can include top surfaces with smooth, straight, continuous peripheries that transition into leading and trailing surfaces LDS and TRS by way of curved wall portions or radii. Alternately, the tie bars could have other cross-sectional shapes and/or varying top surfaces. Additionally, the tie bars are shown as being formed (e.g., molded or vulcanized) integrally with the adjacent tread blocks as well as with bottom surfaces 194 of lateral grooves 176, such as can be formed during the manufacture of the tire tread.

In some cases, a tread pattern in accordance with the subject matter of the present disclosure can include additional tie bars or other sub-surface features, such as may be of substantially uniform size, shape, configuration and/or arrangement, and/or such as may be disposed between and operatively interconnect tread blocks that are disposed in a circumferential and have a common (i.e., approximately equal) circumferential shear stiffness value. One example of such additional sub-surface elements is shown in FIG. 3 and identified as tie bars 198 and 200 that extend between and operatively interconnected adjacent tread blocks 168. It will be appreciated that tie bars 198 and 200 are substantially uniform around the circumference of at least one of ribs 150 and 152. Additionally, it will be appreciated that tread blocks 168 are shown as having a substantially uniform size and shape as well as a common circumferential shear stiffness. In some cases, tie bars 198 and 200 can assist with addressing residual aligning torque and/or other tire performance characteristics.

As indicated above, tread blocks of a wide variety of combinations of sizes, shapes, configurations and/or arrangements can be and are commonly used in connection with the formation of tread patterns for tires. As such, it will be appreciated that the size, shape, configuration and arrangement of tread blocks and grooves shown and described in connection with FIGS. 3-5 is merely exemplary and that pluralities of tread blocks having any suitable combination of sizes, shapes, configurations and/or arrangements can alternately be used together with the subject matter of the present disclosure.

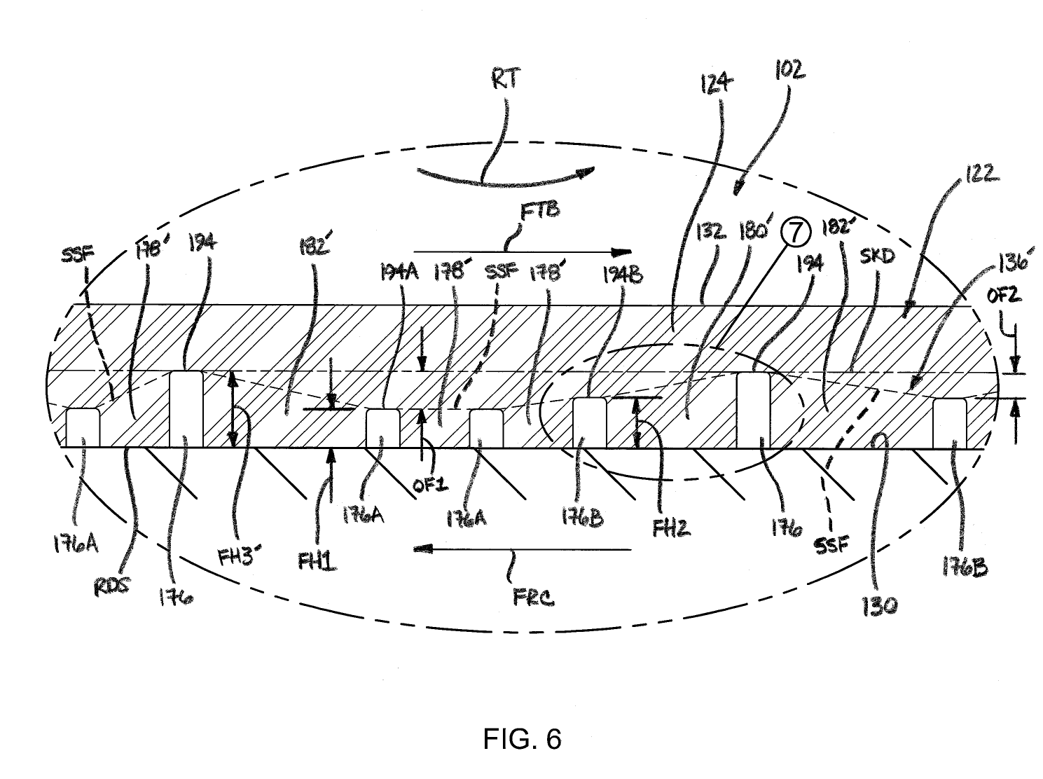

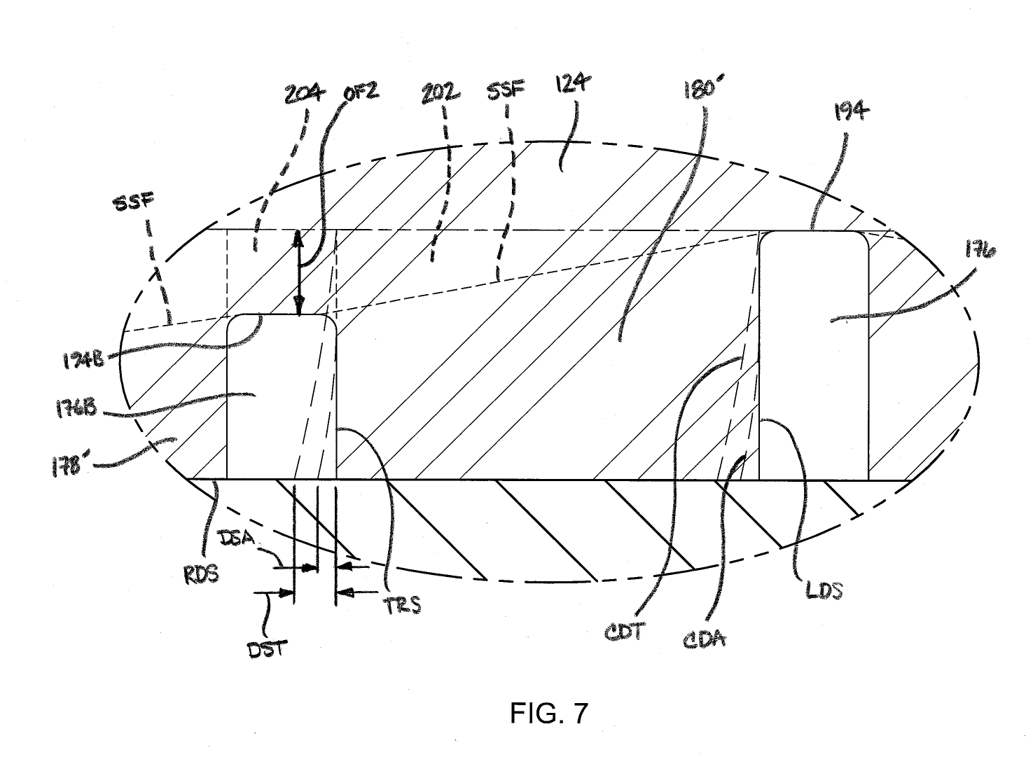

FIGS. 6 and 7 illustrate another non-limiting example of a tread pattern in accordance with the subject matter of the present disclosure, which is identified therein as tread pattern 136′. It will be appreciated that tread pattern 136′ is substantially similar to tread pattern 136 in FIGS. 3-5 in that tread pattern 136′ can include circumferential ribs 150-156 and 162, circumferential grooves 158, 160, 164 and 166, and lateral grooves 170, 176 and 184, such as have been generally described above. Additionally, the combination of circumferential and lateral grooves can at least partially define tread blocks 178′, 180′ and 182′ that are substantially similar to tread blocks 178, 180 and 182, such as have been described above. Tread pattern 136′ differs from tread pattern 136 in that tread pattern 136′ includes a plurality of sub-surfaces features of a different type, kind and construction than tie bars 188, 190 and 192 of FIGS. 3-5.

As described above, circumferential grooves 158, 160, 164 and 166 as well as at least lateral grooves 176 can extend into crown portion 124 of tire casing 122 from along outer surface 130 to a bottom surface 194 that is disposed at a skid depth, which is represented in FIGS. 6 and 7 by dashed line SKD. As shown in FIGS. 6 and 7, however, portions of circumferential grooves 158, 160, 164 and/or 166 can have a reduced skid depth along and/or adjacent at least one surface of one or more of the tread block variations. As illustrated in greater detail in FIG. 7, portions of the bottom surface of circumferential grooves 158, 160, 164 and/or 166 can have an irregular circumferential shape. Additionally, or in the alternative, portions of the bottom surface of at least lateral grooves 176 can have an irregular shape. In this manner, certain portions of the of the bottom surface of grooves 158, 160, 164, 166 and/or 176 can function as sub-surface features that bolster, buttress or otherwise support one or more surfaces of tread blocks 178′, 180′ and/or 182′, such as is represented in FIGS. 6 and 7 by dashed line SSF, for example. Additionally, or in the alternative, irregularly-shaped bottom surfaces of the lateral grooves can function as sub-surface features that bolster, buttress or otherwise support one or more surfaces of tread blocks 178′, 180′ and/or 182′.

In a preferred arrangement, the irregular shaped bottom surfaces of one or more circumferential grooves and a plurality of lateral grooves blend or otherwise cooperatively engage one another to form a laterally and circumferentially-extending network of grooves having a substantially-continuous but irregularly-shaped surface that results in the generation of a plurality of different tread block variations having different unsupported free heights. One example of such a construction is shown in FIGS. 6 and 7 in which circumferential and lateral grooves have a bottom surface portion that is offset from skid depth SKD by an offset dimension OF1 adjacent tread blocks 178′ and by an offset dimension OF2 adjacent tread blocks 180′. As a result, lateral grooves 176A are shown as terminating at a bottom surface 194A and having a reduced depth relative to lateral grooves 176. What's more, tread blocks 178′ are shown as having an unsupported free height FH1 along one or more surfaces thereof (e.g., leading surface LDS and/or trailing surface TRS, described above). Additionally, lateral grooves 176B are shown as terminating at a bottom surface 194B and having a greater depth than lateral grooves 176A but a reduced depth relative to lateral grooves 176. As such, tread blocks 180′ are shown as having an unsupported free height FH2 that is greater than unsupported free height FH1 but less than unsupported free height FH3′ of tread blocks 182′.

It will be appreciated that the bottom surface portions of the circumferential and lateral grooves that are offset from skid depth reference line SKD can be formed during the formation of the tire tread pattern. As such, a quantity of elastomeric (e.g., rubber material) can form offset wall sections of a variety of sizes and shapes that are integrally formed as portions of elastomeric casing 122. Exemplary offset wall sections are identified in FIG. 7 as offset wall sections 202 and 204. It will be recognized and appreciated that, under some conditions, offset wall section 204 could function as a tie bar extending from skid depth reference line SKD to bottom surface 194B and circumferentially between tread blocks 180′ and another tread block. A similar offset wall section (not shown) could extend between skid depth reference line SKD and bottom surface 194A and circumferentially between tread blocks 178′ and another tread block. Additionally, an offset dimension (e.g., OF1 and OF2) of less than 50% of the total skid depth (e.g., skid depth SKD) is preferred. The overall groove profile of a tread pattern in accordance with the subject matter of the present disclosure can, in some cases, have from two (2) to twenty (20) identifiable tread depths. Preferably, such a tread pattern can have from four (4) to ten (10) identifiable tread depths.

With reference to FIGS. 1 and 4-7, a torque TRQ (FIG. 1) is applied to tire and wheel assembly 100 that induces rotation of the assembly in the direction represented by arrows RT. For a given tread block disposed at a radius R (FIG. 1) from axis AX, the force FTB generated at the given tread block is equal to the torque TRQ divided by the tire radius R, such that FTB=TRQ/R, as is well-known in the art. As tire 102 engages road surface RDS, a corresponding reaction force FRC is generated by the road surface torque that acts in the direction opposite that of tread block force FTB. It will be appreciated that the magnitude of reaction force FRC will be a function of the coefficient of friction acting between tire 102 and road surface RDS, as is well known in the art.

As outer surface 130 of tire 102 engages road surface RDS, reaction force FRC generates deflection of the tread blocks in and adjacent footprint 196 of the tire. As shown in FIG. 7, dashed line CDT is representative of the theoretical circumferential deflection of a given tread block (e.g. tread block 180′) having a conventional configuration. Dashed line CDA is representative of the actual circumferential deflection of the given tread block with one or more sub-surface features operatively associated with the given tread block in accordance with the subject matter of the present disclosure. As shown in FIG. 7, reference dimension DPT represents the displacement of outer surface 130 for a given tread block having a conventional configuration. Reference dimension DPA represents the displacement of outer surface 134 the given tread block with one or more sub-surface features operatively associated therewith in accordance with the subject matter of the present disclosure. It will be recognized from FIG. 7 that the circumferential deflection and outer surface displacement of a given tread lug will be greater for a conventional tread block than for a tread block with one or more sub-surface features in accordance with the subject matter of the present disclosure. In some cases, theoretical circumferential shear (TCS) stiffness values and adjusted circumferential shear (ACS) stiffness values can be approximately equal to the reaction force FRC divided by the theoretical or actual outer surface displacement DST or DSA, respectively.

As discussed above, current, known tread pattern designs can include tie bars and other sub-surface features to modify the performance of the tire tread patterns. However, such known constructions typically utilize tie bars and other sub-surface features that are disposed a singular depths circumferentially around the tire. The subject matter of the present disclosure includes the use of tie bars and/or other sub-surface features that include different depths or heights to tune the tread performance at any position 360° around the tire.

As discussed above, the sub-surface features could include tie bars, radii or buttresses at the base of the tread blocks and/or modifications to the overall skid depth in areas of a tread pattern that are non-circumferential. For example, a tire with a noise-treated tread pattern or design may have a range of different size tread features with some larger tread elements and some smaller tread elements. In such cases, the larger tread elements will naturally be stiffer than the smaller tread elements. Upon reducing the effective skid depth around the smaller tread elements a resulting alteration or tuning of the circumferential shear stiffness of the smaller tread elements can be achieved. In this manner, tread blocks can be tuned so that the performance of the total tread pattern can have a more consistent circumferential shear stiffness profile. In some cases, tuning the circumferential shear stiffness of the total tread pattern can include matching the stiffness of the different block shapes to 3-D voids or block edge thicknesses.

The use of different tread depths in different areas of the tire tread pattern can, under some circumstances, benefit features other than circumferential shear stiffness. Such features can include uniformity, void, residual aligning torque and block edge thickness. Additionally, in some cases, a tire that includes a tread pattern in accordance with the subject matter of the present disclosure could have resulting handling snow and wet performance improvements. In some cases, major circumferential grooves may be expected to be of a constant depth with wear bars.

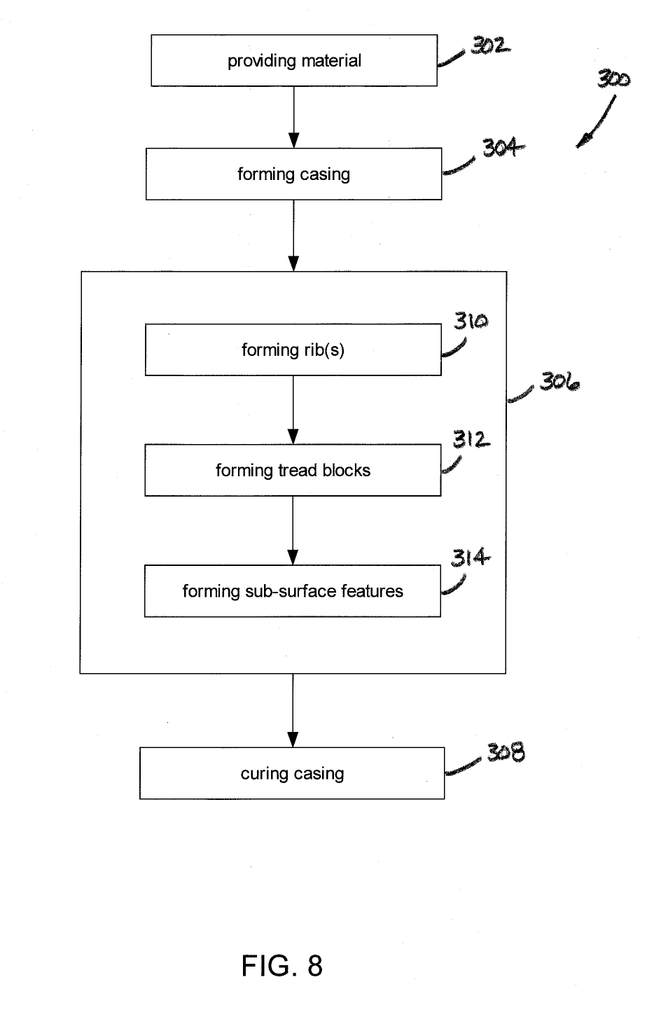

One example of a method 300 of manufacturing a tire having a tread pattern in accordance with the subject matter of the present disclosure is graphically represented in FIG. 8. Method 300 can include providing a quantity of elastomeric material dimensioned to at least partially form a tire casing, as is represented by item number 302. Method 300 can also include forming a tire casing from the quantity of elastomeric material, such as elastomeric casing 122, for example, that extends circumferentially about an axis of rotation, as is represented by item number 304. Method 300 can further include forming a tread pattern, such as tread pattern 136 or 136′, for example, extending circumferentially about the axis and along an outer surface (e.g. outer surface 130) of the tire casing, as is represented by item number 306. Method 300 can also include curing the tire casing and tread pattern, as is represented by item number 308.

As shown in FIG. 8, action 306 of forming a tread pattern can include forming one or more circumferentially ribs along the tire casing, as is represented by item number 310. Action 306 can also include forming a plurality of tread blocks, such as tread blocks 178, 180, 182, 178′, 180′ and/or 182′, for example, in spaced relation to one another along a circumferential rib, as is represented by item number 312. Action 306 can further include forming a plurality of sub-surface features, such as sub-surface features 188, 190, 192 and/or SSF, for example, adjacent at least one of the tread blocks, as is represented by item number 314.

As used herein with reference to certain features, elements, components and/or structures, numerical ordinals (e.g., first, second, third, fourth, etc.) may be used to denote different singles of a plurality or otherwise identify certain features, elements, components and/or structures, and do not imply any order or sequence unless specifically defined by the claim language. Additionally, the terms “circumferential,” “circumferentially,” and the like, are to be broadly interpreted and can include, but are not limited to circular shapes and/or configurations. In this regard, the terms “circumferential,” “circumferentially,” and the like, can be synonymous with terms such as “peripheral,” “peripherally,” and the like.

It will be recognized that numerous different features and/or components are presented in the embodiments shown and described herein, and that no one embodiment may be specifically shown and described as including all such features and components. As such, it is to be understood that the subject matter of the present disclosure is intended to encompass any and all combinations of the different features and components that are shown and described herein, and, without limitation, that any suitable arrangement of features and components, in any combination, can be used. Thus it is to be distinctly understood claims directed to any such combination of features and/or components, whether or not specifically embodied herein, are intended to find support in the present disclosure.

Thus, while the subject matter of the present disclosure has been described with reference to the foregoing embodiments and considerable emphasis has been placed herein on the structures and structural interrelationships between the component parts of the embodiments disclosed, it will be appreciated that other embodiments can be made and that many changes can be made in the embodiments illustrated and described without departing from the principles hereof. Obviously, modifications and alterations will occur to others upon reading and understanding the preceding detailed description. Accordingly, it is to be distinctly understood that the foregoing descriptive matter is to be interpreted merely as illustrative of the subject matter of the present disclosure and not as a limitation. As such, it is intended that the subject matter of the present disclosure be construed as including all such modifications and alterations insofar as the same come within the scope of the appended claims and any equivalents thereof.

1. A tire having an axis of rotation, said tire comprising:
a tread extending circumferentially about said axis and including:
a plurality of tread blocks arranged in a tread pattern, said plurality of tread blocks including a plurality of occurrences of a first tread block having a first theoretical circumferential shear (TCS) stiffness value and a plurality of occurrences of a second tread block having a second TCS stiffness value that is greater than said first TCS stiffness value, said plurality of occurrences of said first tread block and said plurality of occurrences of said second tread block disposed in spaced relation to one another in a first circumferential row extending about said axis and in a predetermined sequence of said first and second tread blocks; and,
a plurality of sub-surface features including a plurality of occurrences of at least a first sub-surface feature with at least some of said plurality of occurrences of said first sub-surface feature operatively associated with at least some of said plurality of occurrences of said first tread block such that a combination of one of said first tread blocks and one of said first sub-surface features has a first adjusted circumferential shear (ACS) stiffness value that is closer to said second TCS stiffness value than said first TCS stiffness value.

2. A tire according to claim 1 further comprising an elastomeric tire casing extending circumferentially about said axis and including an outer surface with said tread extending into said elastomeric tire casing from along said outer surface.

3. A tire according to either one of claims 1 and 2, wherein said tire is a pneumatic tire dimensioned for mounting on an associated wheel.

4. A tire according to any one of claims 1-3, wherein said tread includes a second circumferential row extending about said axis with said first and second circumferential rows spaced axially from one another such that at least one groove extends circumferentially about said axis between said first and second circumferential rows.

5. A tire according to any one of claims 1-4, wherein the difference in values between said first TCS stiffness value of said first tread blocks and said second TCS stiffness value of said second tread blocks is at least partially attributable to a difference in at least one of shape and size between said first and second tread blocks, and said difference in at least one of shape and size corresponds to a noise-reducing tread pattern of said tread.

6. A tire according to any one of claims 1-5, wherein said plurality of tread blocks includes a plurality of occurrences of a third tread block disposed along said circumferential row in a predetermined sequence of said first, second and third tread blocks, said plurality of occurrences of said third tread block having a third TCS stiffness value that is greater than said first TCS stiffness value of said plurality of occurrences of said first tread block and that is greater than said second TCS stiffness value of said plurality of occurrences of said second tread block.

7. A tire according to claim 6, wherein said plurality of sub-surface features includes a plurality of occurrences of second sub-surface features operatively associated with said plurality of occurrences of said second tread block such that a combination of one of said second tread blocks and one of said second sub-surface features has a second ACS stiffness value that is closer to said third TCS stiffness value than said second TCS stiffness value.

8. A tire according to any one of claims 1-7, wherein at least said first circumferential row has an overall circumferential shear stiffness profile that varies circumferentially about said axis, said overall circumferential shear stiffness profile being at least partially established by said first ACS stiffness value of said plurality of occurrences of said first tread block and said second TCS stiffness value of said plurality of occurrences of said second tread block.

9. A tire according to any one of claims 1-8, wherein at least said first ACS stiffness value and said second TCS stiffness value of said first circumferential row are within a range of approximately 70 percent to approximately 130 percent of an average stiffness value of said plurality of tread blocks of said first circumferential row.

10. A tire according to claim 9, wherein at least said first ACS stiffness value and said second TCS stiffness value of said first circumferential row are within a range of approximately 80 percent to approximately 120 percent of an average stiffness value of said plurality of tread blocks of said first circumferential row.

11. A tire according to any one of claims 1-10, wherein said plurality of tread blocks each include a leading surface and a trailing surface with said trailing surface of one of said plurality of tread blocks disposed in facing relation to a leading surface of an adjacent one of said plurality of tread blocks such that a lateral groove extends therebetween.

12. A tire according to claim 11, wherein said first sub-surface features extend from said trailing surface of at least some of said plurality of occurrences of said first tread block toward said leading surface of an adjacent one of said plurality of tread blocks.

13. A tire according to any one of claims 1-12, wherein said plurality of sub-surface features includes a plurality of first tie bars with at least one first tie bar extending from one of said plurality of occurrences of said first tread block and operatively connected to an adjacent one of said plurality of tread blocks.

14. A tire according to claim 13, wherein said plurality of sub-surface features includes a plurality of second tie bars with at least one second tie bar extending from one of said plurality of occurrences of said second tread block and operatively connected to an adjacent one of said plurality of tread blocks.

15. A tire according to claim 14, wherein said plurality of first tie bars have a first height and a first width, and said plurality of second tie bars have a second height and a second width with at least one of said second height and said second width being less than a respective one of said first height and said first width.

16. A tire according to either one of claims 14 and 15, wherein said plurality of tread blocks each include an outer surface, said plurality of first tie bars include a first top surface spaced radially inward a first depth from said outer surface of an adjacent one of said plurality of tread blocks, and said plurality of second tie bars include a second top surface spaced radially inward a second depth from said outer surface of an adjacent one of said plurality of tread blocks, said second depth being greater than said first depth such that said plurality of occurrences of said first tread block have a first unsupported height extending from said first top surface to said outer surface and said plurality of occurrences of said second tread block have a second unsupported height extending from said second top surface to said outer surface that is less than said first unsupported height.

17. A tire according to any one of claims 1-16, wherein said plurality of sub-surface features includes a plurality of skid depths disposed circumferentially about said axis with at least a first skid depth disposed along said plurality of occurrences of said first tread block and operatively connected to an adjacent one of said plurality of tread blocks.

18. A tire according to claim 17, wherein said plurality of sub-surface features includes a second skid depth disposed along said plurality of occurrences of said second tread block and operatively connected to an adjacent one of said plurality of tread blocks.

19. A tire according to either one of claims 17 and 18, wherein said plurality of tread blocks each include a leading surface and a trailing surface, and at least some of said plurality of occurrences of said first tread block have a first free height along at least one of said leading surface and said trailing surface and at least some of said plurality of occurrences of said second tread block have a second free height along at least one of said leading surface and said trailing surface with said first free height being greater than said second free height.

20. A method of manufacturing a tire, said method comprising:
providing a quantity of elastomeric material dimensioned to at least partially form a tire casing;
forming a tire casing including a casing wall extending circumferentially about an axis of rotation;
forming a tread pattern along at least a portion of said casing wall, said tread pattern including a plurality of tread blocks and a plurality of sub-surface features, said plurality of tread blocks including a plurality of occurrences of a first tread block and a plurality of occurrences of a second tread block, said plurality of occurrences of said first tread block and said plurality of occurrences of said second tread block disposed in spaced relation to one another in a circumferential row extending about said axis and in a predetermined sequence of first and second tread blocks, said plurality of sub-surface features including a plurality of occurrences of at least a first sub-surface feature with said plurality of occurrences of said first sub-surface feature operatively associated with at least said plurality of occurrences of said first tread block; and,
curing said tire casing to form a tread pattern in which said plurality of occurrences of said first tread block have a first theoretical circumferential shear (TCS) stiffness value, said plurality of occurrences of said second tread block have a second TCS stiffness value that is greater than said first TCS stiffness value, and a combination of one of said first tread blocks and one of said first sub-surface features has a first adjusted circumferential shear (ACS) stiffness value that is closer to said second TCS stiffness value than said first TCS stiffness value.
